(19) United States
(12) Patent Application Publication
(10) Pub. No.: US 2003/0080862 A1
(43) Pub. Date: May 1, 2003

(54) Tire pressure monitoring system

(76) Inventor: Mark J. Kranz, Hallsville, TX (US)

Correspondence Address: Todd W. Galinski, Kilpatrick Stockton LLP, 1001 West Fourth Street, Winston-Salem, NC, 27101, US

(21) Appl. No.: 10/284,907

(22) Filed: Oct. 31, 2002

Related U.S. Application Data
(60) Provisional application No. 60/334,187, filed on Oct. 31, 2001.

(51) Int. Cl. B60C 23/00

(52) U.S. Cl. 340/442; 340/572.8

(57) ABSTRACT

This invention relates to systems and methods for monitoring tire pressure using radio frequency identification (RFID). The RFID systems of the present invention include a reader and a RF tag in communication with a pressure sensor. The reader of the present invention comprises an oscillator, modulator, transmitting antenna, receiving antenna and demodulator. The RF tag comprises an antenna, diode detector, comparator, controller and pressure sensor interface. The RF tag further comprises a battery which powers the electronic components of the tag. In embodiments of the present invention, the oscillator generates a signal that is fed to the modulator for encoding information. The modulated signal is then broadcast via the antenna to the RF tag. An antenna on the RF tag received the signal where the comparator and controller interpret the information sent by the reader, receive a pressure reading from the pressure sensor and transmit an encoded signal back to the reader via modulation of reflected energy. The reader in turn receives this reflected energy and demodulates the signal to retrieve the encoded information including the pressure reading.

### CROSS REFERENCE TO RELATED APPLICATIONS

This application claims priority to U.S. Provisional Application No. 60/334,187 filed Oct. 31, 2001, the disclosure of which is herein incorporated by reference.

### BACKGROUND OF THE INVENTION

1. Field of the Invention

This invention relates to vehicle tire pressure monitoring systems, and more specifically to a monitoring system which utilizes backscatter radio frequency identification (RFID) to relay tire pressure information from a radio frequency (RF) tag on the tire to a remote reader.

2. Background of the Related Art

A number of monitoring devices are know for use with pneumatic vehicle tires which measure the pressure within a tire and transmit the data to a remotely positioned receiver and operator interface. For example, U.S. Pat. No. 3,713,092 to Ivenbaum, which is herein incorporated by reference, discloses a conventional tire pressure monitoring system which includes a cylindrical detector which is threadably engaged with a tire valve stem and transmits a radio signal in response to a low tire pressure condition to a remotely located receiver.

In this conventional monitoring system, the locally installed detector generally includes a pressure transducer, and electrical switch, a sensor device, a transmitter and a battery. In operation, the pressure transducer measures the pressure within the tire. When a low pressure condition is detected, the electrical switch is actuated. The sensor monitors the position of the electrical switch, which is either open or closed, and activates the battery-powered transmitter when the sensor and switch are in the low pressure state. The transmitter when activated sends a plurality of RF signals to the remotely located receiver. The receiver is electrically connected to a display device positioned within the operator compartment.

A disadvantage associated with conventional tire pressure monitoring systems of this type is that battery life is quite limited due to the data transmission power requirements. As a result, the absence of a low pressure signal does not necessarily mean that the tire pressure is satisfactory. If the battery is dead, the detector is effectively disabled, and no warning of a low pressure condition is provided. The battery life problem is exacerbated by the fact that when a low pressure condition occurs, the load placed on the battery by the transmitter rapidly drains the battery and renders the device inoperable. Other prior art devices have incorporated a battery level indicator in the monitoring system to provide a mechanism for informing the operator of when the detector has been disabled due to a low or dead battery. However, battery life in these devices is still limited and frequent battery replacement is still required.

The tire pressure monitor disclosed in U.S. Pat. No. 4,734,674 to Thomas et al. has attempted to eliminate the low battery problem by including a counter in the detector assembly. The counter in the detector records the number of coded signal bursts that have been transmitted and disables the transmitter, thereby conserving the battery, when a predetermined number of signal bursts have been sent. Although the battery life has been extended, the system has been disabled and only reactivated when a high pressure value is sensed or when manually reset.

Another problem associated with the prior art tire pressure monitoring system is the difficulty in determining which tire is low. The difficulty is of particular relevance with large commercial vehicles, which often have eighteen or more wheels. Conventional tire pressure monitors only indicate that a low pressure reading has been encountered, but do not identify the location of the tire experiencing low pressure. As a result, the operator upon receiving a low pressure signal must manually check each tire to determine the source of the low pressure signal.

Thus, there is a need for a tire pressure monitoring system which allows the tire pressure to be sensed locally and monitored remotely over an extended period of time without the battery limitation associated with prior art devices. Further, there is a need for a system which can also discriminate which tire on a vehicle is the one experiencing low pressure.

### BRIEF DESCRIPTION OF THE DRAWINGS

FIG. 1 illustrates a schematic of an embodiment of a radio frequency identification system comprising a reader and a RF tag according to the present invention.

### SUMMARY OF THE INVENTION

The present invention relates to a radio frequency identification system for monitoring tire pressure comprising a reader, a semi-passive RF tag, a pneumatic tire and a pressure sensor functionally connected to the tire and in communication with the RF tag. The pressure sensor is capable of communicating tire pressure readings to the RF tag, which in turn is capable of communicating these readings to the reader by modulating backscatter to correspond to said pressure readings. This allows the tire pressure to be checked from a distance remote from the vehicle and while the vehicle is in motion.

The present invention also relates to a method for determining pressure within a tire comprising the steps of generating an RF signal with a reader device, receiving the RF signal in the RF tag, measuring the pressure in a tire with a pressure sensor communicating the pressure measurement to an RF tag, modulating the antenna on the RF tag to encode the pressure information in a reflected RF signal, reflecting the modulated signal with the pressure information encoded therein from the RF tag, receiving the modulated signal from the RF tag within the reader and demodulating the signal from the RF tag and decoding the information encoded within the signal.

A feature and advantage of the present invention is the ability to determine improperly inflated tires from a position remote from the tire, thereby allowing the tire pressure to be monitored without having to physically check each tire with a pressure gauge.

Another feature and advantage of the present invention is the ability to determine improperly inflated tires while a vehicle is in motion.

Another feature and advantage of the present invention is the ability to determine whether several tires are properly inflated simultaneously. Furthermore, the present invention allows tire pressure on different vehicles to be checked with one measuring device. Thus, a fleet of vehicles may be checked from a control room at a warehouse or garage to verify that all tires are properly inflated as the vehicles enter or leave the lot. This will reduce the chance of accidents and decrease liability associated with operating a commercial fleet of vehicles.

Another feature and advantage of the present invention is the use of a semi-passive RF tag to relay tire pressure information, which has a longer life span than active tags and can transmit over long ranges than passive tags.

### DETAILED DESCRIPTION OF THE INVENTION

The present invention relates to tire pressure monitoring systems that utilize radio frequency identification (RFID) technology to transmit tire pressure information to a remote receiver. The system does not require a dedicated power source at the sensing/sending location for the purposes of data transmission and is able to locate the position of the sensor as well as receive the pressure reading.

The use of passive or semi-passive RF identification systems to read data from an electronic “tag” are well known in the art and have been used in applications such as inventory monitoring systems as described in U.S. Pat. No. 5,850,187 to Carrender et al. and U.S. Pat. No. 6,078,251 to Landt et al., both of which are herein incorporated by reference.

Typically, such a system includes a reader, also called a radar or transceiver for generating a modulated or unmodulated radio frequency interrogation signal, detecting a return signal from an electronic tag, and a signal processor for processing the return signal. In a further embodiment, the RFID system further includes a user interface for initializing commands and a user display for communicating information associated with the pressure reading.

RF tags operate by receiving a signal from a reader, processing the signal and then reflecting energy back to the reader (backscatter). There are two types of RFID devices used in similar applications, passive and semi-passive. Passive RF tags work by receiving energy from a reader and storing the energy until enough energy has been received to run the electronic components on the tag. Once the energy threshold has been met, the tag modulates the antenna characteristics to reflect some of the energy back to the reader. The reader receives this reflected energy thus indicating that some of the energy being emitted is returning in an intelligent manner.

Passive RF tags may operate inductively or through a direct electric field. The most common are inductive RF tags which typically operate at a frequency of 13.25 MHz. Newer RF tags have been operating at higher frequencies which allow them to become capacitive in nature and take advantage of far field effects. These newer tags can operate at 915 MHz or 2.45 GHz, however their typical range is still limited to about 3 meters.

The second type of RF tag further comprises a power source such as a battery to provide power to the onboard electronics. It is important to note that in this system the battery is not used to transmit a signal, but rather, only to operate the electrical systems located on the RF tag. Since the battery powers the onboard circuitry, the reader only has to send enough power to alert the RF tag and then make the return reflection back to the reader. This greatly improves the range of the system because in the passive RF tag scenario described above, the onboard electronics use most of the power leaving little to be reflected back to the reader. The systems using a battery to operate the onboard electronics are referred to as semi-passive RF tags. These systems generally operate in the 900 MHz and 2.45 GHz bands and have an operational range of over 100 meters in some applications. This is the preferred embodiment of RF tag for use in the present invention.

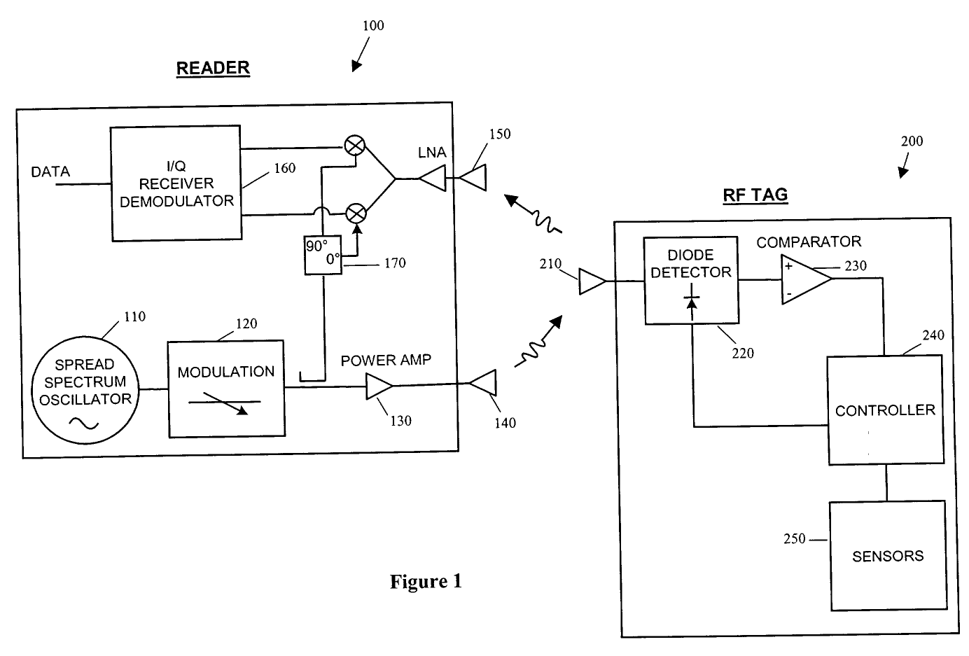

A typical reader for use in the present invention can be viewed in FIG. 1. These devices are often referred to as radar since they operate on similar principles. An oscillator 110 generates a signal at a frequency within the operating band of the RF tag 200. The frequency of the signal is modulated by a frequency modulator 120 in order to communicate with the RF tag 200. The outgoing signal is encoded through modulation to communicate instructions to the RF tag. In order to achieve a low cost tag comprising simple components, a simple modulation scheme is preferable. The most preferred modulation scheme is bi-phase modulation. After modulation the signal is split into pieces. One part of the signal is amplified in a power amplifier 130 and broadcast through an antenna 140. The other piece of the signal is sent to the demodulator 160 on the receive side of the reader.

The semi-passive RF tag comprises an antenna 210, tuned to absorb energy in a predetermined band, diode detector 220 which rectifies the signal, turning the radio signal into a voltage, and comparator 230 that compares the voltage from the diode detector 220 to a set voltage or activation voltage. A battery (not shown) powers these electronic components thereby eliminating the need to receive and store power from the reader for the purposes of operating the on board electronics.

When the proper activation voltage is received by the RF tag, indicating that the reader is broadcasting a request for information, the comparator 230 signals the microcontroller 240 which times how long the energy impinges the antenna 210 and when it stops. The microcontroller 240 uses this data to determine the modulation of the signal, and decoding the information sent from the reader.

Once the reader 100 transmits the modulated command, the modulator 120 in the reader turns off and the reader 100 broadcasts unmodulated energy to the RF tag 200. The RF tag 200 uses this unmodulated signal to communicate back to the reader 100.

The form of the reflected energy will vary depending on input from the pressure sensor 250. The RF tag 200 modifies the reflected energy by modulating or unmodulating its antenna 210. In one embodiment of the present invention, the RF tag's antenna 210 is modulated by shunting the antenna to ground, which causes slight fluctuations in the reflected signals amplitude. Information may be communicated from the RF tag to the reader through various predetermined antenna modulation schemes, as is known in the art.

In one example embodiment, if the RF tag is modulating its antenna according to the above embodiment, the reflected energy will have two sidebands corresponding to the frequency of modulation. If the RF tag is not modulating its antenna, the energy is reflected back unmodulated to the reader. Additionally, the tag may use biphase modulation by turning on and off the modulating frequency of its antenna for intervals of time. By modulating the antenna according to a predetermined format the RF tag is able to communicate pressure conditions and other information back to the reader through the reflected energy. In addition to pressure conditions, the RF tag may communicate information such as available power in the battery to operate the electronics on the tag.

The reader 100 receives the reflected or backscatter energy from the RF tag 200 in either modulated or unmodulated form. The reader 100 then uses the second piece of the signal split off from the oscillator before the amp and antenna, and mixes this signal with the received signal from the tag. The split waveform is a replica of the one the reader received back from the tag differing only in amplitude and having a small delay due to the time it took to transit to the tag and be reflected back. The mixing of the two signals removes the carrier wave and leaves only the modulation in the case where the tag was modulating its antenna and leaving only a DC offset when the tag was not modulating its antenna. Information, i.e. the pressure reading, is extracted based on the length of time the tag modulated and then did not modulate. This resulting signal can be digitized and the data displayed or otherwise reported. Furthermore, any information may be communicated through a series of modulation and non-modulation of the backscatter energy according to a predetermined code recognized by the reader.

Due to wave effects, the distance of the reader from the tag will occasionally cause deconstructive interference. This occurs when two waves meet and cancel each other out. In the present invention, the signal from the oscillator used to down convert the incoming signal and the incoming reflected signal might cancel each other out so that nothing is received by the demodulator. This creates a null or blind spot at a particular distance where the reader is unable to process the reflected RF tag signal. This null will vary based on the wavelength such that each frequency has nulls at particular distances every half wavelength. Therefore, these nulls will occur every half wavelength of the distance the signal travels, so the signal will go from a perfect reflection to nothing every quarter wavelength.

This problem is solved by shifting the signal used to down convert the received signal by 90 degrees, thereby producing two channels offset by a quarter wavelength. Thus, one signal entering the signal splitter 170 leaves as two signals offset by 0 and 90 degrees. The demodulator can then mix the signal received from the tag with each of the channels, delayed 0 and 90 degrees. This guarantees that if one channel is completely nullified by the incoming signal, the other results in a perfect copy. In another embodiment of the present invention, frequency shifting is used to solve the problem of wave cancellation. The reader hops from one frequency to another throughout the spectrum. If one frequency results in a nullified signal, a different frequency traveling the same distance will likely result in a processable signal.

In an embodiment of the present invention, the position of the tag may be determined using the above-mentioned phenomena of deconstructive interference. The reader broadcasts at one wavelength and looks for a null or blind spot. If there is a null, the reader calculates the distances at which those nulls would occur for the broadcast wavelength. This process is repeated across the entire band until a set of frequencies resulting in nulls is obtained. The distances at which nulls would occur for all the resulting frequencies is compared to determine the one distance at which all the frequencies would produce a null. This is the distance from the reader to the tag.

Depending upon the nature of the use of the present invention, it may be desirable to continuously monitor the tire pressure such as in a vehicle in motion. In other applications, it is desirable to check tire pressure readings at a specific point such as when a service or fleet vehicle passes the gate at a storage lot. In one embodiment of the present invention, the reader continuously emits a signal and is available to receive a return signal from an RF tag. In another embodiment of the present invention, the interrogator pulses the signal at predetermined intervals or when prompted by an operator.

In a preferred embodiment of the present invention, the reader is in further communication with a display device or other user interface that allows a user to visually observe the tire pressure readings. This may be incorporated into a tire monitoring system in a vehicle storage lot, or into a hand-held, portable reader. In another embodiment of the present invention, the reader and user interface is incorporated into a vehicle dashboard display to allow tire pressure to be monitored by the driver while the vehicle is in motion.

In the preferred embodiment of the present invention, the reader is mounted at the entrance to a storage yard and tags are placed on the tires of trucks stored therein. As the trucks pass the reader at the entrance to the yard, pressure readings are collected and passed to the maintenance department. Maintenance of the vehicles is then scheduled based on these readings.

In another embodiment of the present invention, the reader and display device are integrated into a hand held unit. This enables a person to monitor the tire pressure of several vehicles or vehicles in different locations. The hand held unit contains a reader as well as a display for communicating the signal readings to the user. This embodiment is particularly useful in applications where a single user checks many vehicles and/or tires. This also provides portability to the device allowing one device to be used in several different applications or locations.

In another embodiment of the present invention, a display device is mounted on the dashboard or integrated into other vehicle status displays in the driver compartment. When a low pressure condition is sensed and communicated from the tire to the reader, the reader relays the information, including the location of the problem tire to the user interface. The operator of the vehicle is then alerted to the low pressure condition through conventional means such as warning lights or audio signals in the driver compartment.

The various embodiments of the present invention may be employed in any situation in which pressure is monitored from a remote location. The embodiments and examples described herein generally relate to cars and trucks, however other applications are envisioned to be within the scope of the present invention. For example, the present invention may be used to monitor tire pressure on aircraft, heavy industrial equipment, bicycles or any other pressurized wheel vehicle.

The distance at which a tag can be read is dependant upon the strength of the signal being emitted by the reader as well as the sensitivity on the receiving side of the reader and the antenna characteristics and comparator circuitry of the tag. The power of the reader is limited by the size of the unit as well as the power source. Currently, semi-passive RF tags can be activated at a range of over 100 meters in some applications. Furthermore, the readers are capable of reading up to 500 RF tags.

The present invention also comprises a pressure sensor to measure the pressure and convert the pressure reading to an electrical signal. In one embodiment of the present invention the pressure sensor 250 is an integral part of the RF tag 200 such that the two devices comprise one unit. In another embodiment of the present invention, the pressure sensor is a separate device in communication with the RF tag 200 at a sensor interface 250.

Any pressure sensor known in the art may be used in the practice of the present invention as long as it may be functionally connected to the RF tag. In a preferred embodiment of the present invention, the pressure sensor comprises a piezoelectric pressure sensor in which a voltage is applied across a diaphragm coated with piezo crystals. A pressure difference across the diaphragm causes the crystals to shift in relation to one another thereby creating a change in resistively across the terminals. This change in resistively is measured and communicated to the RF tag. The foregoing is merely an example of a pressure sensor for use with the present invention. Those skilled in the art will recognize other pressure sensing means which may be employed in the various embodiments of the present invention without altering the spirit or scope of the present invention.

The pressure sensor may be mounted at any location on or in the tire. In a preferred embodiment of the present invention the pressure sensor is screwably mounted on the valve stem of the tire. The small size of the sensor and RF tag in embodiments of this invention reduce the breakage problems associated with pressure sensors of the prior art. Those skilled in the art will recognize that the pressure sensor may be built into the tire, mounted on the tire or mounted on the tire rim. One advantage of mounting the pressure sensor within the tire is the elimination of any external device that is exposed to the elements and dirt from the road or which may break off if the tire contacts rocks, curbs or other uneven driving surfaces.

Although the present invention has been described with reference to particular embodiments, it should be recognized that these embodiments are merely illustrative of the principles of the present invention. Those of ordinary skill in the art will appreciate that the sealing member and assembly of the present invention may be constructed and implemented with other materials and in other ways and embodiments. Accordingly, the description herein should not be read as limiting the present invention, as other embodiments also fall within the scope of the present invention.

I claim:

1. A radio frequency identification system for monitoring tire pressure comprising:
a reader;
a semi-passive RF tag;
a pneumatic tire; and,
a pressure sensor functionally connected to the tire and in communication with the RF tag;
wherein the pressure sensor is capable of communicating tire pressure readings to the RF tag, which in turn is capable of communicating these readings to the reader by modulating backscatter to correspond to said pressure readings.

2. The system of claim 1 wherein the reader unit comprises an oscillator for generating a signal, a modulator for modulating said signal, an antenna for broadcasting said signal, an antenna for receiving an incoming backscatter signal, and a demodulator for demodulating the incoming signal.

3. The system of claim 1 wherein the semi-passive RF tag comprises an antenna for receiving a signal from a reader, a comparator for comparing the signal to a predetermined level, a controller for determining the modulation of the signal, a sensor interface for receiving pressure conditions from the pressure sensor.

4. The system of claim 1 further comprising a display unit in communication with the reader.

5. The system of claim 1 wherein the pressure sensor comprises a piezoelectric pressure sensor.

6. The system of claim 1 wherein the pressure sensor is located inside the tire.

7. The system of claim 1 wherein the pressure sensor is located on the rim of the tire.

8. The system of claim 1 wherein the pressure sensor is located on the valve stem of the tire

9. The system of claim 1 further comprising at least one additional pressure sensor and at least one additional RF tag associated with at least one additional tire.

10. The system of claim 1 further comprising a plurality of pressure sensors and RF tags associated with a plurality of tires on a plurality of vehicles.

11. The system of claim 1 wherein the reader is incorporated into a hand held device further comprising a user interface.

12. A method for determining pressure within a tire comprising:
generating an RF signal with a reader device;
receiving the RF signal in the RF tag;
measuring the pressure in a tire with a pressure sensor;
communicating the pressure measurement to an RF tag;
modulating the antenna on the RF tag to encode the pressure information in a reflected RF signal;
reflecting the modulated signal with the pressure information encoded therein from the RF tag;
receiving the modulated signal from the RF tag within the reader; and
demodulating the signal from the RF tag and decoding the information encoded within the signal.

13. The method of claim 12 wherein the RF signal is generated in a reader comprising an oscillator, modulator, demodulator and at least one antenna.
